(19) United States
(12) Patent Application Publication
(10) Pub. No.: US 2007/0211314 A1
(43) Pub. Date: Sep. 13, 2007

(54) Electronic paper system, log management apparatus, information processing apparatus, computer readable medium, method of image processing and computer data signal

(75) Inventors: Yasunori Saito, Kanagawa (JP); Tsunemasa Mita, Kanagawa (JP); Ikutaroh Nagatsuka, Kanagawa (JP); Tsutomu Ishii, Kanagawa (JP); Minoru Koshimizu, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., TOKYO (JP)

(21) Appl. No.: 11/592,296

(22) Filed: Nov. 3, 2006

(30) Foreign Application Priority Data
Jan. 17, 2006 (JP) 2006-008418

(51) Int. Cl. H04N 1/46

(52) U.S. Cl. 358/504; 40/124.01

(57) ABSTRACT

An electronic paper system that uses an electronic paper comprising a display section displaying an image in a no-power supply state, which includes: a retention unit that stores a display image in association with at least one of the document data and the electronic paper, the display image being generated from document data and displayed on the display section of the electronic paper; and an output unit that outputs the display image stored in the retention unit.

### BACKGROUND

1. Technical Field

This invention relates to an art of using electronic paper for holding display of an image on a display section in a no-power supply state and in particular to an art of storing a display image written to electronic paper.

2. Related Art

Electronic data in various media such as an image and text is handled using a computer and a document is created, edited, read, etc.

To read such an electronic data document, generally a document image is displayed on a display screen of a computer or a document image is printed on paper of a paper medium using a printer.

In recent years, paper-like flexible thin electronic paper capable of holding display of an image in a no-power supply state has been developed as a document read medium that can replace paper.

The electronic paper is a device having a display section for holding display of an information image in a no-power supply state and is roughly classified into self-write type electronic paper having a function of writing an image to the display section for itself based on electronic data and transfer write type electronic paper for holding an image written by projection transfer, thermal transfer, etc., on the display section according to the write manner of an information image to the display section.

Unlike paper, such electronic paper enables to erase or overwrite of the image whose display is held on the display section and can be used repeatedly and therefore it is also desirable to promote the user of the electronic paper from the viewpoint of paper resource savings, etc.

### SUMMARY

According to an aspect of the present invention, an electronic paper system that uses an electronic paper comprising a display section displaying an image in a no-power supply state, which includes: a retention unit that stores a display image in association with at least one of the document data and the electronic paper, the display image being generated from document data and displayed on the display section of the electronic paper; and an output unit that outputs the display image stored in the retention unit.

According to the invention, the display image generated from document data and displayed on electronic paper can be stored and output, so that even after the image on electronic paper is rewritten, the user can output the display image displayed before the rewrite for keeping track of the past display and checking the work accomplished in the past.

Since a new display image can be generated using the stored display image, the user can check the work accomplished in the past by seeing the electronic paper.

### BRIEF DESCRIPTION OF THE DRAWINGS

An exemplary embodiment of the present invention will be described in detail based on the following figures, wherein:

FIG. 1 is a drawing to show the configuration of an electronic paper system according to one embodiment of the invention;

FIG. 2 is a drawing to show the configuration of an electronic paper system according to another embodiment of the invention;

FIG. 3 is a drawing to show the configuration of an electronic paper system according to still another embodiment of the invention;

FIG. 4 is a drawing to show a functional configuration example of an information processing apparatus and an electronic paper printer according to the invention;

FIG. 5 is a drawing to describe the retention contents of electronic paper according to the invention;

FIGS. 6A and 6B are drawings to describe the items of image log data according to the invention;

FIG. 7 is a drawing to describe linking of document data, an image generation log, and an image display log according to the invention;

FIGS. 8A and 8B are drawings to describe display images according to the invention;

FIG. 9 is a drawing to describe an example of a display image according to the invention;

FIG. 10 is a drawing to describe an example of a display image according to the invention;

FIG. 11 is a drawing to describe an example of a display image according to the invention;

FIG. 12 is a drawing to describe an example of a display image according to the invention;

FIG. 13 is a drawing to describe an example of a display image according to the invention;

FIG. 14 is a drawing to describe an example of a display image according to the invention;

FIGS. 15A and 15B are drawings to show an example of external write type electronic paper;

FIG. 16 is a drawing to describe a use method of external write type electronic paper;

FIG. 17 is a drawing to describe the operation principle of external write type electronic paper;

FIG. 18 is a drawing to describe the structure of external write type electronic paper;

FIGS. 19A and 19B are drawings to show an example of self-write type electronic paper;

FIG. 20 is a drawing to describe the operation principle of self-write type electronic paper; and

FIG. 21 is a drawing to describe the structure of self-write type electronic paper.

### DETAILED DESCRIPTION

The invention will be discussed specifically based on embodiments.

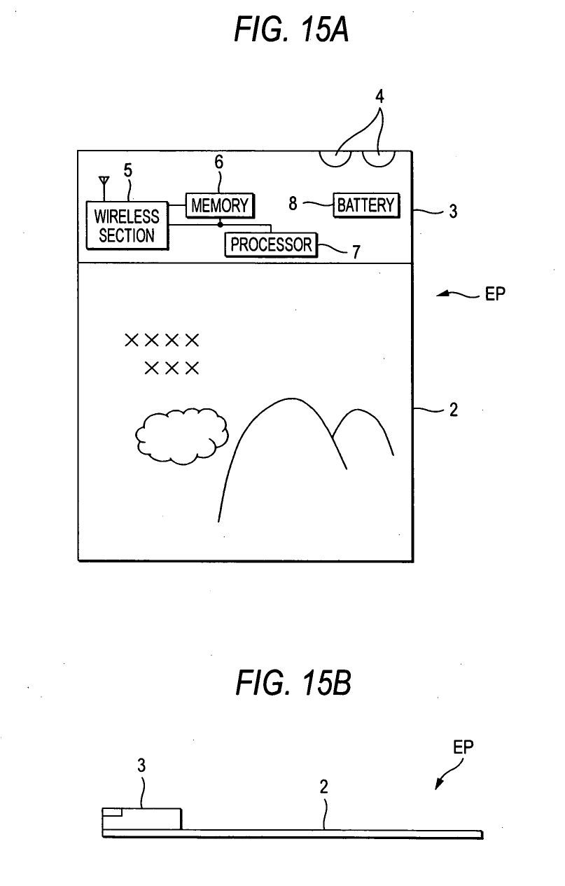

To begin with, electronic paper that can be used with the invention will be discussed specifically with reference to FIGS. 15 to 21.

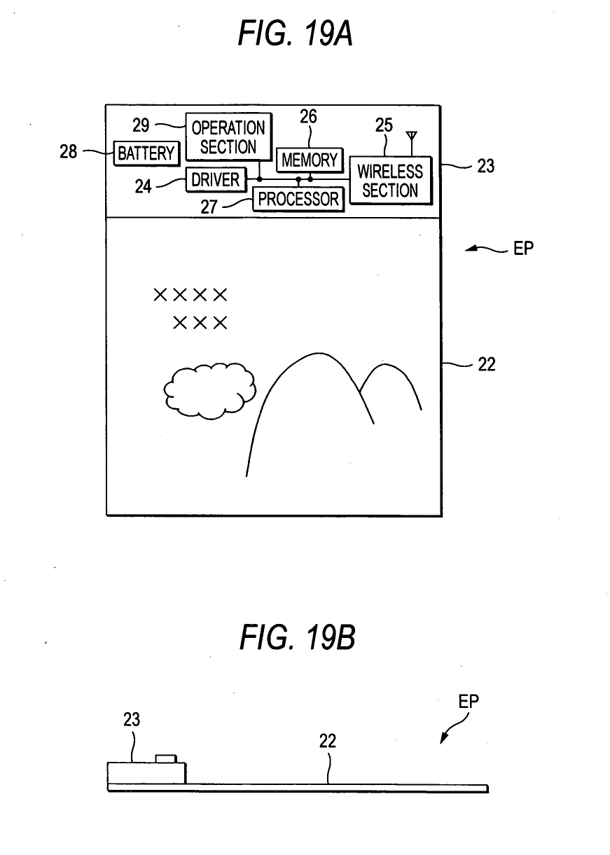

Electronic paper EP is classified into external write type shown in FIGS. 15 to 18 and self-write type shown in FIGS. 19 to 21, for example, according to the record system of images whose display is held, and is a thin information record and retention device like paper as called electronic paper regardless of the type.

FIG. 15A is a front view of optical write type electronic paper EP as an example of the external write type and FIG. 15B is a side view of the optical write type electronic paper EP. The electronic paper EP shown in the figure has a display section 2 for holding display of an image in a no-power supply state and a processing section 3 for performing processing of electronic data of URL, etc., of document data; FIG. 15A also shows the functional parts contained in the processing section 3.

The optical write type electronic paper EP is a flexible thin medium of a size like a card stipulated in the JIS or A4 paper and the processing section 3 is provided on a side of the display section 2 occupying the most area. The size of the display section 2 is arbitrary and to use the electronic paper as a tag or a card as described later, the size of the display section 2 is set in response to the use.

The processing section 3 is provided with write electrodes 4 for applying a voltage for driving the display section 2 as described later, a wireless section 5 for conducting wireless communications with the outside, memory 6 for retaining electronic data readably and writably, a processor 7 for performing processing of access to the memory 6, etc., and a battery 8 for supplying drive power of the processor 7, the wireless section 5, etc.

The optical write type electronic paper EP can transmit and receive electronic data by conducting wireless communications with an external wireless unit (in an example described later, an electronic paper printer) through the wireless section 5 and can retain the electronic data in the memory 6.

In the example shown in the figure, the processing section 3 having a comparatively high data processing function is shown, but known RFID including a wireless communication function of data and a data storage function in a comparatively simple configuration may be used as the processing section 3.

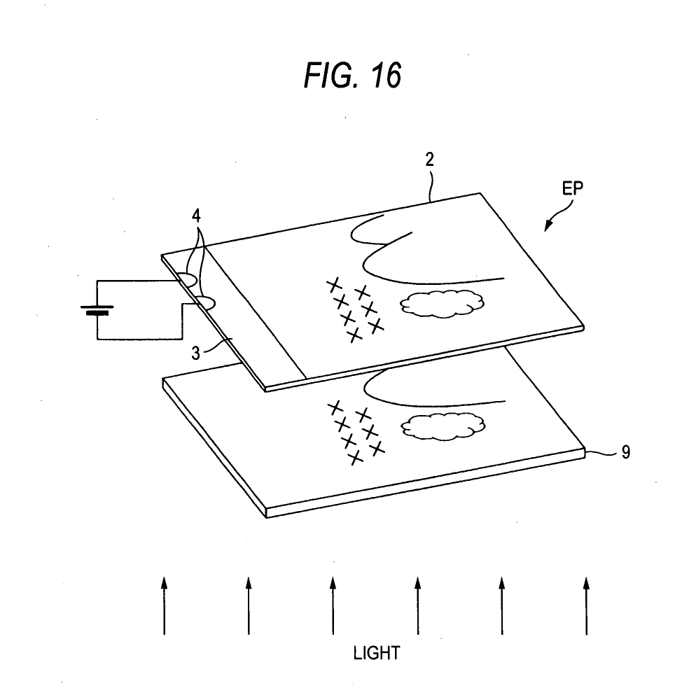

For example, as shown in FIG. 16, an image to be written is displayed on a liquid crystal panel 9 and while the voltage from an external power supply is applied to the electrode 4, the optical write type electronic paper EP is put on the liquid crystal panel 9 and light is applied, whereby the image displayed on the liquid crystal panel 9 can be transferred to the display section 2 for storage. In short, the optical write type electronic paper EP has a function of transferring the projected image to the display section 2 as voltage is applied to the electrode 4 and continuing to hold the image in a display state still after the voltage applied to the electrode 4 is removed.

To use such optical write type electronic paper EP, the electronic paper printer described later includes unit required for optical write, such as a voltage application section to the electrode 4, the liquid crystal panel 9, and a light application section. For example, a printer described in JP-A-2004-106495 can be used as the electronic paper printer.

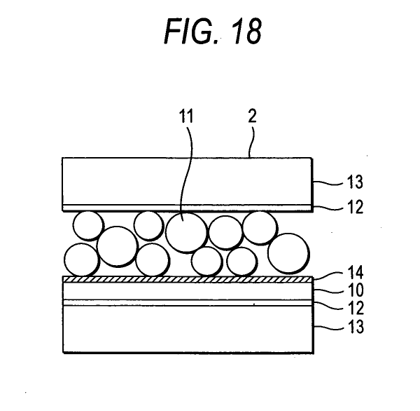

The optical write type electronic paper EP has a structure wherein a layer of organic photoconductive material (organic photoconductive layer) 10 used with a copier and a layer of liquid crystal display material (cholesteric liquid crystal layer put into microcapsules) 11 are used in combination and these layers are sandwiched between a pair of surface and back transparent electrodes 12 and the layered body is sandwiched between a pair of surface and back transparent substrate films 13, as shown in FIG. 18 representing the cross-sectional structure of the display section 2. In the structure, monochrome image display can be produced with white display provided by the cholesteric liquid crystal layer 11 reflecting light and black display as light passes through the liquid crystal layer 11 and is absorbed in a black layer 14 provided between the cholesteric liquid crystal layer 11 and the organic photoconductive layer 10. Further, since the cholesteric liquid crystal has a characteristic of interference reflecting of color light responsive to helical pitches, the cholesteric liquid crystal layer 11 is formed by depositing liquid crystal materials different in helical pitch, so that it is also possible to realize color display as a simple structure.

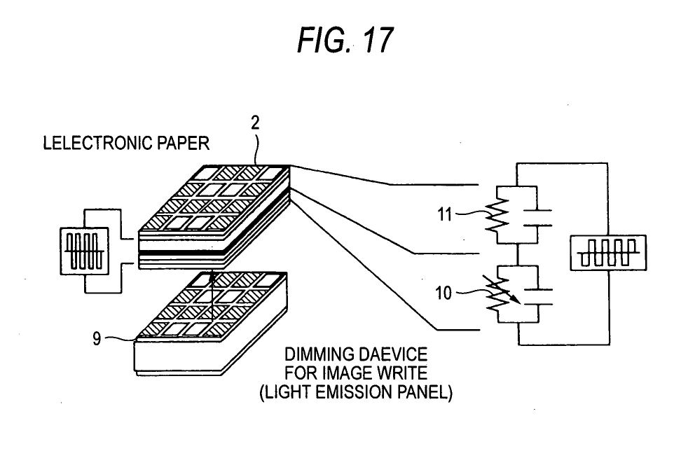

For example, an image to be transferred to the dimming device panel for image write (light emission panel) 9 is displayed on the optical write type electronic paper EP and is projected on the display section 2 and when a voltage is applied to the electrode 4, intensity of light is converted into the reflection density in a moment and the projection image is retained, as shown in FIG. 17 representing the operation principle of the display section 2. An erasion voltage is applied to the electrode 4, whereby the image information retained in the display section 2 can be erased and the optical write type electronic paper EP can be used repeatedly as write and erasion are repeated.

Without performing such erasion processing for the optical write type electronic paper EP, a voltage is applied to the electrode 4 and a new image is projected as described above, whereby the image information retained in the display section 2 can also be overwritten with new information; the optical write type electronic paper EP can be used repeatedly as such overwrite processing is performed.

As another example of the external write type electronic paper EP, the display section 2 may have a thermal recording structure as known and an image may be thermally recorded by a terminal recording head included in an electronic paper printer for holding display of the image on the display section 2.

In a system of the embodiment described later, such thermal recording type electronic paper is formed as the JIS card size and card type electronic paper EP including RFID as the processing section 3 is used.

FIG. 19A is a front view of self-write type electronic paper EP and FIG. 19B is a side view of the self-write type electronic paper EP. The electronic paper EP shown in the figure has a display section 22 for holding display of an image and a processing section 23 for performing processing of electronic data; FIG. 19A also shows the functional parts contained in the processing section 23.

The self-write type electronic paper EP is a flexible thin display and record device of a size like a JIS card and the processing section 23 is provided on a side of the display section 22 occupying the most area. The size of the display section 22 is set in response to the use. The display section 22 and the processing section 23 may be made detachable and, for example, the clip-form processing section 23 may be attached to the display section 22 to form electronic paper EP.

The processing section 23 is provided with a driver 24 for driving the display section 22 as described later, a wireless section 25 for conducting wireless communications with the outside such as an electronic paper printer, memory 26 for retaining electronic data readably and writably, a processor 27 for performing processing of electronic data, and a battery 8 for supplying operation power to the function unit of the processor 27, etc.

The self-write type electronic paper EP can transmit and receive electronic data of a display image by conducting wireless communications with an external wireless unit (electronic paper printer, etc.,) through the wireless section 25 and can retain the electronic data in the memory 26.

The self-write type electronic paper EP can drive the driver 24 under the control of the processor 27 and can rewrite and display an image whose display is held on the display section 22 based on the electronic data retained in the memory 26. The electronic paper EP has a function of continuing to hold an image on the display section 22 in a display state if the drive power of the driver 24 is removed.

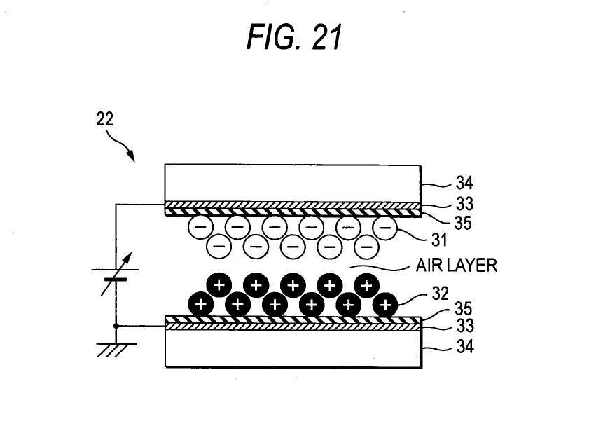

The self-write electronic paper EP has a structure wherein fine colored particles used as toner with a copier (in the example shown in the figure, white particles 31 and black particles 32) are filled between a pair of surface and back electrodes 33 with at least the surface being transparent and they are sandwiched between a pair of surface and back film substrates 34 with at least the surface being transparent, as shown in FIG. 21 representing the cross-sectional structure of the display section 22. An air layer is provided between the electrode layers 33 so as to allow the colored particles 31 and 32 to move freely, and each matrix-like electrode layer 33 is provided with an insulating layer 35 for preventing the electrode layer from coming in contact with the colored particles 31 and 32. Using a color filter, color display can also be realized as a simple structure.

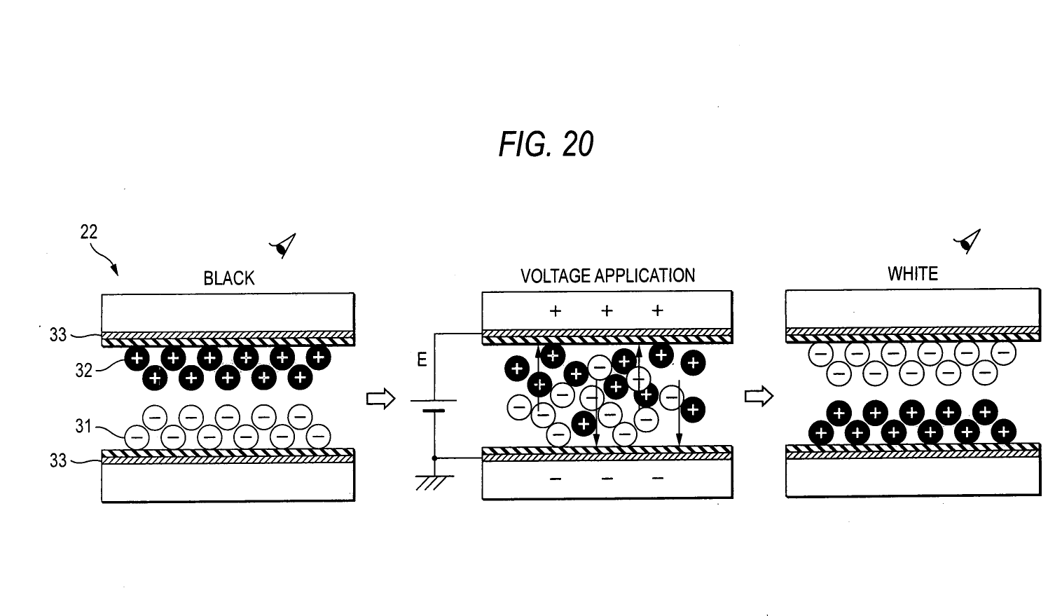

In the self-write electronic paper EP, the negatively (minus) charged white particles 31 remain on the back and the positively (plus) charged black particles 32 remain on the surface in a state in which no voltage is applied to the electrode 33 (however, the electrode 33 is charged in the polarity at the previous drive time) and if the user visually observes the display section 22 from the surface, the display section 22 is placed in a black state, as shown in FIG. 20 representing the operation principle of the display section 22. When the driver 24 operates based on the image data and the electrode polarity of the required part of the matrix responsive to the image to be displayed is inverted, the positional relationship between the white particles 31 and the black particles 32 is replaced and an image based on the contrast between the white particles 31 and the black particles 32 is displayed on the display section 22. The driver 24 is operated based on different image data, whereby image information displayed on the display section 22 based on the contrast between the white particles 31 and the black particles 32 can be switched and the electronic paper EP can be reused repeatedly.

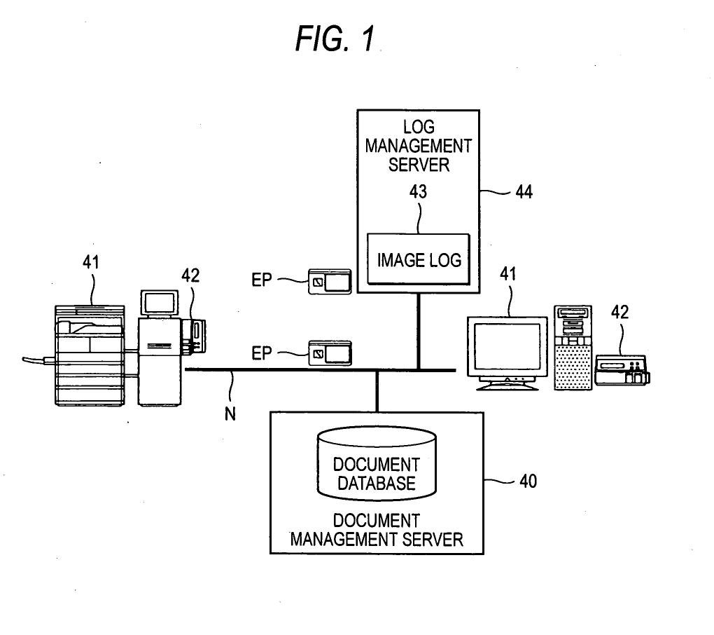

FIG. 1 shows a general configuration example of an electronic paper system according to one embodiment of the invention.

The system of the embodiment is made up of a document management server (document management apparatus) 40, information processing apparatus 41, and a log management server (log management apparatus) 44, which are connected by a network N, with an electronic paper printer 42 added to each information processing apparatus 41.

The document management server 40, which has a document database for identifying document data according to URL and storing the document data, stores and manages document data received from the information processing apparatus 41, and is responsive to a request received from one of the information processing apparatus 41 for transmitting the corresponding document data to the requesting information processing apparatus 41.

In the example shown in the figure, a multiple function processing machine (MF) including a combination of a scanner function, a copy function, a FAX function, etc., and a personal computer (PC) are used as the information processing apparatus 41. A display image is written to electronic paper EP on the electronic paper printer 42 added to the information processing apparatus 41 as write unit and is also transmitted to the log management server 44 for storage.

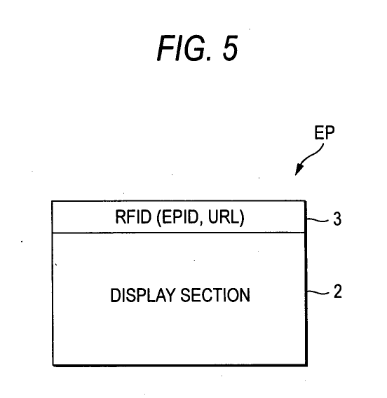

In the system of the embodiment, transfer write type electronic paper (card) EP is used and RFID 3 provided in electronic paper card EP stores the EPID (electronic paper identification information) preset in the electronic paper card EP and the URL of document data associated with the electronic paper card EP (storage location information of the document data), as shown in FIG. 5.

The electronic paper printer 42 reads the EPID and the URL from the RFID 3 of the placed electronic paper card EP and sends them to the information processing apparatus 41 and receives a display image generated by the information processing apparatus 41 and writes and retains the display image to and in the display section 2 of the electronic paper card EP. It also receives the URL together with the display image and stores it in the RFID 3. Accordingly, the relation between the electronic paper card EP and the document data is updated.

The log management server 44 has retention unit (hereinafter also simply referred to as an “image log retention unit”) 43 for storing a display image in association with the URL and the EPID. The image log retention unit 43 receives the URL and the EPID together with the display image from the information processing apparatus 41 and stores the display image in association with the URL and the EPID and transmits the corresponding display image to the information processing apparatus 41 in response to a request received from the information processing apparatus 41.

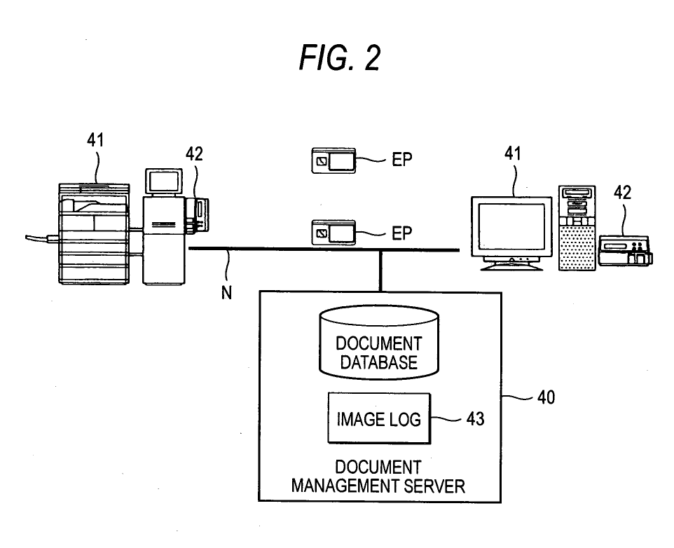

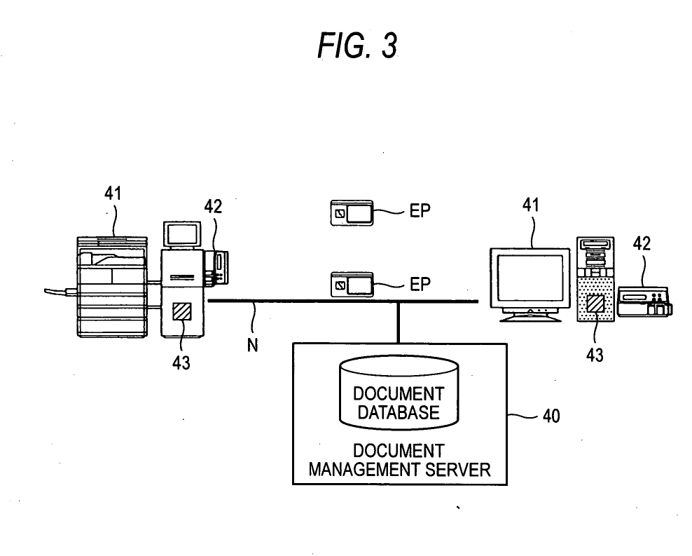

In FIG. 1, the image log retention unit 43 is included in the log management server 44, but may be included in the document management server 40 as shown in FIG. 2 or may be included in each information processing apparatus 41 as shown in FIG. 3; it may be provided so as to enable each information processing apparatus 41 to acquire the required display image.

If each information processing apparatus 41 includes the image log retention unit 43 as in FIG. 3, preferably each information processing apparatus 41 stores its generated display image in the image log retention unit 43 in association with the URL of the document data used to generate the display image and the EPID of the electronic paper card EP to which the display image is written and transmits the URL and the EPID and the display image to another information processing apparatus 41 and stores the URL and the EPID and the display image received from another information processing apparatus 41 in the image log retention unit 43.

Accordingly, the storage contents of the image log retention unit 43 are synchronized between the information processing apparatus 41, so that a display image G generated by one information processing apparatus 41 can be used in another information processing apparatus 41.

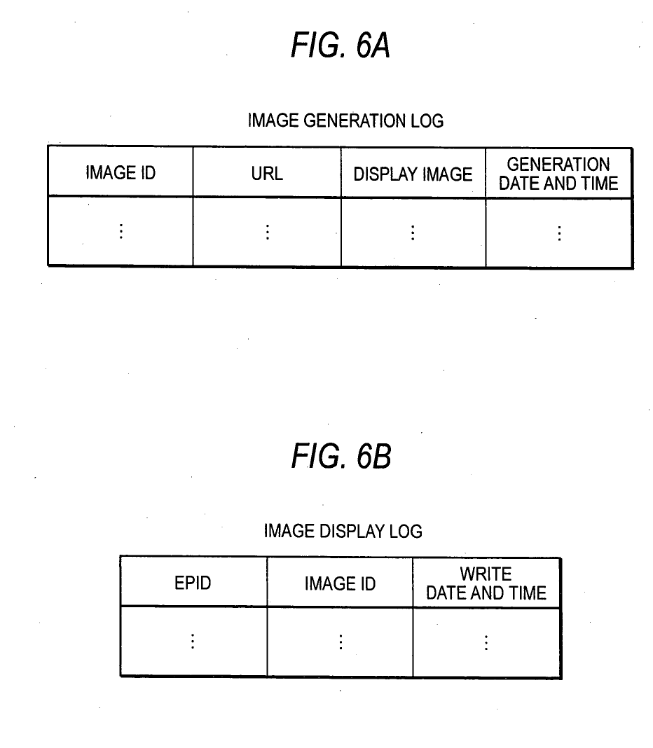

The image log retention unit 43 of the embodiment stores an image generation log as shown in FIG. 6A and an image display log as shown in FIG. 6B.

The image generation log is made up of “image ID” for identifying the display image, “URL” indicating the storage location of the document data used to generate the display image, “display image” of electronic data of the display image, and “creation date and time” of the display image; the log is stored each time a display image is generated from document data.

The image display log is made up of “EPID” for identifying the electronic paper card EP, “image ID” for identifying the display image displayed on the electronic paper card EP, and “write date and time” of writing the display image to the electronic paper card EP; the log is stored each time a display image is written to electronic paper card EP. That is, for example, if the display image written to another electronic paper card EP in the past is written to electronic paper card EP intact without generating any display image, the EPID of the electronic paper card EP and the image ID of the past display image and the write date and time are stored in association with each other.

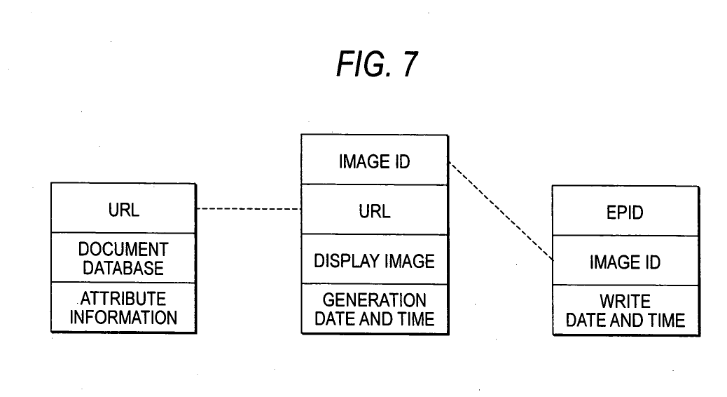

The document data used to generate the display image and the image display log and the image generation log are linked as shown in FIG. 7. The document data and the image generation log are associated with each other according to the URL indicating the storage location of the document data and attribute information involved in the document data (name, creation date and time, correction date and time, creator name, etc.,), and the image generation log and the image display log are associated with each other according to the image ID identifying the display image.

Therefore, the display image generated from one document data can be acquired from the image generation log associated according to the URL of the document data. The display image written to one electronic paper card EP can be acquired from the image generation log associated according to the image ID in the image display log corresponding to the EPID of the electronic paper card EP.

Prior to the detailed description of the invention, storage processing and read processing of document data using an electronic paper card EP, basic processing of the electronic paper system, will be discussed.

The systems shown in FIGS. 1 to 3 are similar and therefore the above-mentioned processing examples will be discussed using the system shown in FIG. 1 as the representative system.

To begin with, in the storage processing, document paper with a document printed thereon is read through a scanner of the multiple function processing machine (MF) 41 in a state in which an electronic paper card EP is placed in the electronic paper printer 42 of the multiple function processing machine (MF) 41. The multiple function processing machine (MF) 41 stores the read document data and the attribute information of the read date and time, etc., of the document in the document management server 40 through the network N, generates a display image based on the read document data, writes and retains the display image to and on the display section 2 of the electronic paper card EP on the electronic paper printer 42, and transmits the URL of the document data stored in the document management server 40 to the RFID of the electronic paper card EP for storage.

Accordingly, the electronic paper card EP ejected from the electronic paper printer 42 holds display of a display image indicating an outline of the document data read and stored in the document management server 40 and stores the URL to access the document data.

Therefore, the user sees the display image whose display is held on the electronic paper card EP and can easily find out any desired document. For example, the user places the electronic paper card EP in the electronic paper printer 42 of the personal computer (PC) 41, acquires the URL from the RFID of the electronic paper card EP through RFID access unit of the electronic paper printer 42 (reader/writer), and accesses the document management server 40 according to the URL using the PC 41, whereby the document data associated with the electronic paper card EP (display image) can be read, be acquired, and be displayed on a screen.

The user drags and drops document data stored in the PC 41, for example, a document data icon displayed on the screen onto an electronic paper printer icon in a state in which the electronic paper card EP is placed in the electronic paper printer 42 of the PC 41 for performing write processing concerning the document data. That is, the PC 41 stores the document data and the attribute-information of the document data in the document management server 40 through the network N, generates a display image based on the document data, writes and retains the display image to and on the display section 2 of the electronic paper card EP on the electronic paper printer 42, and transmits the URL of the document data stored in the document management server 40 to the RFID of the electronic paper card EP for storage.

Accordingly, the electronic paper card EP ejected from the electronic paper printer 42 holds display of a display image indicating an outline of the document data and stores the URL to access the document data in a similar manner to that described above.

For example, the user places the electronic paper card EP in the electronic paper printer 42 of the MF 41 and acquires the URL from the RFID of the electronic paper card EP through RFID access unit of the electronic paper printer 42 or through RFID access unit of the MF 41 if the MF 41 includes the RFID access unit, whereby the corresponding document data is acquired according to the URL using the MF 41 and document paper can be printed out.

The display image generated from the document data and displayed on the electronic paper card EP is transmitted to the log management server 44 through the network N and is stored in the image log retention unit 43 as described above. Therefore, the user can acquire the display image generated in the past from the document data being processed or the display image written in the past to the electronic paper card EP being processed from the image log retention unit 43, can check the display image as the display image is output to the screen or is printed out, and can look back the work accomplished in the past.

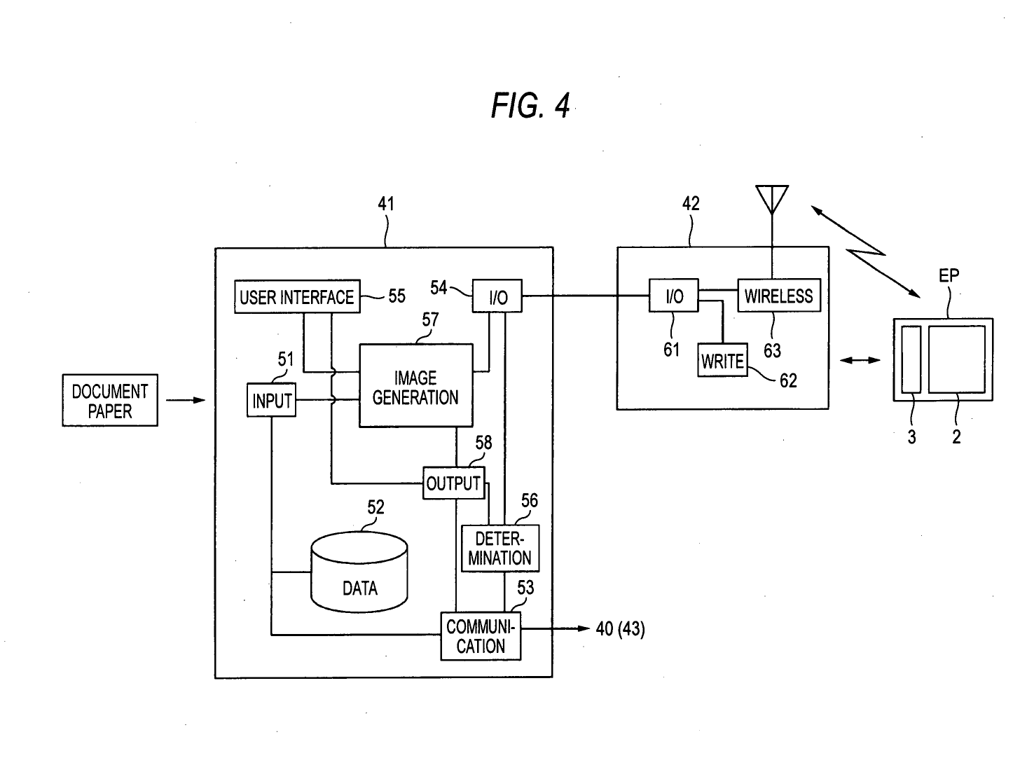

FIG. 4 shows an example of the functional configurations included in the information processing apparatus 41 and the electronic paper printer 42 to execute the processing described above. In the example shown in the figure, the multiple function processing machine (MF) is shown as the information processing apparatus 41, but the personal computer (PC) can also be applied in a similar manner.

The information processing apparatus 41 in the example is a computer and the following functional unit 51 to 58 are implemented as the computer executes programs according to the invention.

The information processing apparatus (MF) 41 has input unit 51 for providing various input functions required for the multiple function processing machine, such as a scanner function and a communication function, memory 52 for retaining data of input image information, etc., for processing, communication unit 53 for conducting communications of transmitting the document data read through the scanner to the document management server (DS) 40, etc., an interface (I/O) 54 for connection to the electronic paper printer 42, user interface unit 55 for accepting information presentation to the user and command input from the user, determination unit 56 for determining the past display image corresponding to the URL and the EPID stored in the RFID 3 of the electronic paper card EP placed in the electronic paper printer 42, output unit 58 for acquiring the determined display image from the image log retention unit 43 and outputting the display image, and image generation unit 57 for generating a new display image using the output display image.

The electronic paper printer 42 has an interface (I/O) 61 for connection to the information processing apparatus 41, write unit 62 for executing transfer write of an image to the display section 2 of the electronic paper card EP, and wireless unit 63 for conducting wireless data communications of the EPID, the URL, etc., with the RFID 3 of the electronic paper card EP.

In the example, the information processing apparatus 41 and the electronic paper printer 42 which are separate are connected, but the information processing apparatus 41 and the electronic paper printer 42 may be integrated into one body. In the example, the information processing apparatus 41 includes the determination unit 56, but the electronic paper printer 42 or the document management server (DS) 40 may include the determination unit 56.

The output unit 58 of the information processing apparatus 41 acquires the past display image corresponding to the document data specified through the user interface unit 55 or the electronic paper card EP from the image log retention unit 43 and displays the display image on the screen of the information processing apparatus 41, enabling the user to check the display images going back to the past.

If the number of the corresponding past display images is more than one, the display images can be listed, enabling the user to list the past display images generated from specific document data in the generation date and time order for checking the process of the work using the document data and the user to list the display images displayed in the past on the electronic paper card EP in the write date and time order for checking the process of the work using the electronic paper card EP.

Each of the display images contains an image of additional information of the manipulation name indicating manipulation on the document data (for example, new creation, edit, erasion, display output, printout, etc.,), the name of the information processing apparatus 41 used for the manipulation, the manipulation date and time, etc., for example, enabling the user to check the description of the work accomplished in the past, like what manipulation was performed on which document data using which information processing apparatus 41.

To determine the document data or the electronic paper card EP involved in the output unit 58, the document data or the electronic paper card EP may be determined not only by a command input through the user interface 55, but also using the URL or the EPID read from the RFID 3 of the electronic paper card EP placed in the electronic paper printer 42.

The output unit 58 also has a function of providing the past display image acquired from the image log retention unit 43 for the image generation unit 57 as electronic data for the image generation unit 57 to generate a new display image, and the image generation unit 57 can generate a new display image using the electronic data of the past display image.

Therefore, seeing electronic paper, the user can check the display image generated in the past from the document data to be processed and the display image displayed in the past on the electronic paper to be processed and can also check the work description as the additional information as described above is contained in the display image. The corresponding past display images are listed, enabling the user to keep track of the process of the work using the document data and the process of the work using the electronic paper by seeing the electronic paper.

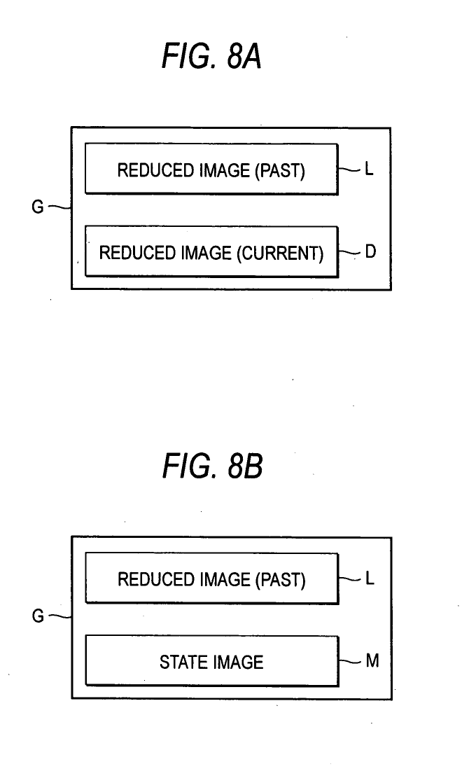

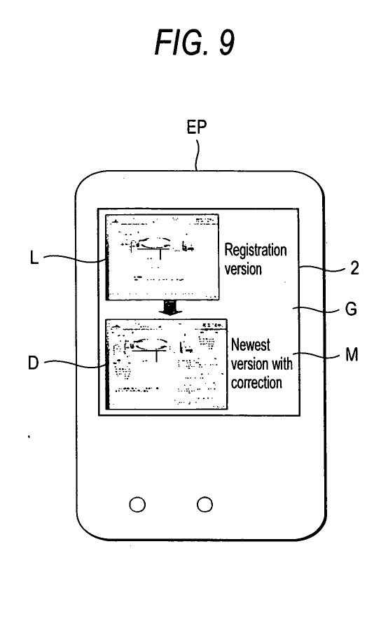

FIG. 8 shows examples of display images G written to the display section 2 of the electronic paper card EP. Each of the new display images G is generated using the past display image. The display image G contains a reduced image OLE_LINK4 (past) L of the past display image and a reduced image (current) D generated from the current document data as shown in FIG. 8A and the display image G contains a reduced image (past) L of the past display image and a state image M indicating the state of the current document data (for example, with correction, already erased, etc.,) as shown in FIG. 8B. FIGS. 9 to 14 show examples of the display images G.

In the example shown in FIG. 9, to contrast a reduced image (current) D generated based on the current document data with a reduced image (past) L of the past display image generated when the document data was first stored in the document management server 40 and indicate the state of the document data, a state image M with “newest version with correction” added to the reduced image (current) D and “registration version” added to the reduced image (past) L is added to generate a display image G and the display image G is displayed on the display section 2 of the electronic paper card EP.

The image generation unit 57 generates the display image G as follows:

When the determination unit 56 determines the document data from the URL stored in the RFID 3 of the electronic paper card EP, the image generation unit 57 acquires the correction date and time from the attribute information of the corresponding document data retained in the document management server 40, acquires the most recent generation date and time of the corresponding display-image from the image log retention unit 43, and makes a comparison between the correction date and time and the most recent generation date and time.

If the most recent generation date and time is newer than the correction date and time, the document data is not corrected after the display image was previously generated and therefore the preceding display image (with the most recent generation date and time) provided from the output unit 58 is displayed on the display section 2 of the electronic paper card EP as the display image G.

If the correction date and time is newer than the most recent generation date and time, the document data is corrected after the display image was previously generated and therefore a reduced image (current) D is generated based the document data, a reduced image (past) L is generated from the display image with the oldest generation date and time provided from the output unit 58, a state image M describing correction is generated, the images are combined into a display image G, and the display image G is displayed on the display section 2 of the electronic paper card EP and is also stored in the image log retention unit 43.

Accordingly, seeing the electronic paper, the user can keep track of the fact that the document data has been corrected. If the document data is not corrected after the display image was previously generated, the preceding display image is displayed on the electronic paper card EP and thus time and labor of image generation can be saved.

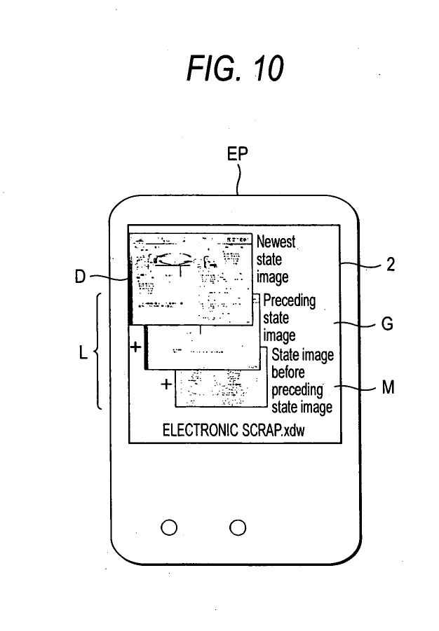

In the example, the reduced image of the display image with the oldest generation date and time is used, but the reduced image of the display image with the most recent generation date and time (namely, the preceding display image) may be used. In the example, only one past reduced image is used, but more than one may be used as shown in FIG. 10.

FIG. 10 shows another example of display image G where the reduced image (current) D and the reduced image (past) L shown in FIG. 9 are displayed in comparison. According to the figure, for example, in an electronic scrap document created by merging the document image scan input to the information processing apparatus (MF) 41 with the document data of the URL stored in the RFID 3 of the electronic paper card EP, a display image G containing a reduced image (current) D of the current merged display image, reduced images (past) L of preceding and preceding preceding merged display images, and a state image M of “newest,” “preceding,” and “preceding preceding” describing the correction process of the document data is displayed on the display section 2 of the electronic paper card EP.

The generation processing of the display image G in the figure by the image generation unit 57 is similar to that previously described with reference to FIG. 9 and therefore will not be discussed again. Thus, plural reduced images (past) L of the past display image are used to generate the display image G, so that the user can check the correction process of the document data.

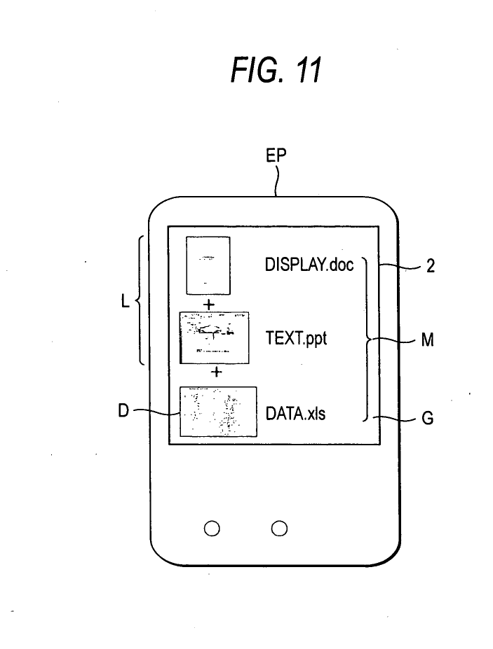

In the example shown in FIG. 11, in a combined document provided by combining plural pieces of document data different in format such as “display.doc,” “text.ppt,” and “data.xls,” only “data.xls,” is corrected and a display image G containing a reduced image (current) D generated based on corrected “data.xls,” reduced images (past) L of preceding display images generated based on “display.doc” and “text.ppt,” and a state image M describing them is displayed on the display section 2 of the electronic paper card EP.

The image generation unit 57 generates the display image G as follows:

When the determination unit 56 determines the document data, the image generation unit 57 acquires the correction date and time from the attribute information of the corresponding document data retained in the document management server 40 about the document data of each of “display.doc,” “text.ppt,” and “data.xls,” acquires the most recent generation date and time of the corresponding display image from the image log retention unit 43, and makes a comparison between the correction date and time and the most recent generation date and time.

The most recent generation date and time is newer than the correction date and time for each of “display.doc” and “text.ppt” and thus the document data is not corrected and a reduced image (past) L is generated from the preceding display image provided from the output unit 58. The correction date and time is newer than the most recent generation date and time for “data.xls,” and thus the document data is corrected and a reduced image (current) D is generated based the document data. The names are acquired from the attribute information of the corresponding document image retained in the document management server 40, a state image M is generated, they are combined into a display image G, and the display image G is displayed on the display section 2 of the electronic paper card EP and is also stored in the image log retention unit 43.

Accordingly, to generate the display image G of a combined document into which plural pieces of document data are combined, a reduced image (current) D is generated only for the corrected document data and the preceding display image is used as a reduced image (past) L for the uncorrected document data, so that the generation time of the display image G can be shortened.

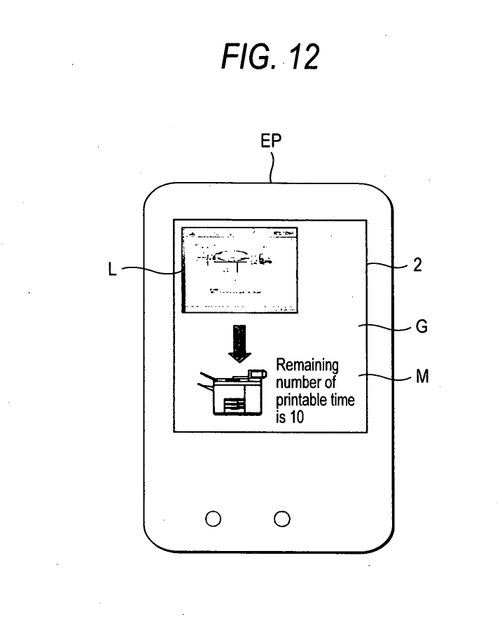

In the example shown in FIG. 12, a display image G containing a reduced image (past) L of document data and a state image M indicating the remaining number of print times to allow the document data to be printed is displayed on the display section 2 of the electronic paper card EP.

The remaining number of print times is recorded in the attribute information added to the document data and is decremented by one each time the information processing apparatus (MF) 41 prints out the document data, and the information processing apparatus (MF) 41 controls so as to inhibit printing of the document data after the remaining number of print times becomes 0.

The image generation unit 57 generates the display image G as follows:

When the determination unit 56 determines the document data, the image generation unit 57 acquires the correction date and time from the attribute information of the corresponding document data retained in the document management server 40, acquires the most recent generation date and time of the corresponding display image from the image log retention unit 43, and makes a comparison between the correction date and time and the most recent generation date and time.

If the most recent generation date and time is newer than the correction date and time, the document data is not corrected after the display image was previously generated and therefore a reduced image (past) L is generated from the preceding display image provided from the output unit 58. If the correction date and time is newer than the most recent generation date and time, the document data is corrected after the display image was previously generated and therefore a new reduced image (current) D is generated based the document data. The remaining number of print times is acquired from the attribute information of the document data, a state image M is generated and is combined with the reduced image (past) L or the reduced image (current) D into a display image G, and the display image G is displayed on the display section 2 of the electronic paper card EP and is also stored in the image log retention unit 43.

Accordingly, if the document data is not corrected, the reduced image (past) L of the past display image is used, so that the generation time of the display image G can be shortened.

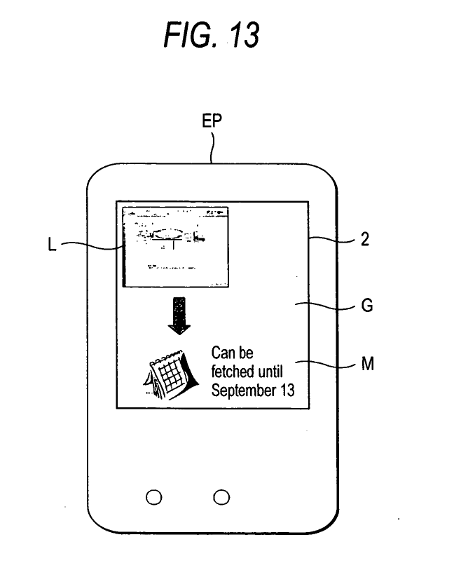

In the example shown in FIG. 13, a display image G containing a reduced image (past) L of document data and a state image M indicating the expiration date to allow the document data to be fetched into the information processing apparatus 41 is displayed on the display section 2 of the electronic paper card EP.

The fetch expiration date is recorded in the attribute information added to the document data and the document management server 40 controls so as to inhibit fetching of the document data when the expiration date is exceeded.

The generation processing of the display image G in the figure by the image generation unit 57 is similar to that previously described with reference to FIG. 12 and therefore will not be discussed again.

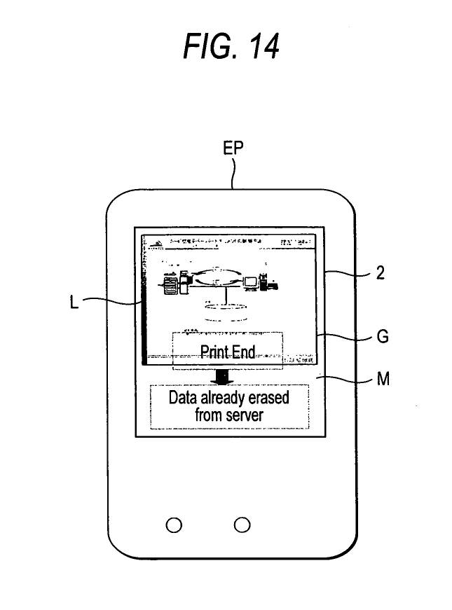

In the example shown in FIG. 14, a display image G containing a reduced image (past) L of document data and a state image M of “Print end” and “data already erased from server” indicating that the document data is printed out and is already erased from the document management server 40 is displayed on the display section 2 of the electronic paper card EP.

The image generation unit 57 generates the display image G as follows:

When the determination unit 56 determines the document data from the URL stored in the RFID 3 of the electronic paper card EP, the image generation unit 57 first determines whether or not the document management server 40 retains the document data corresponding to the URL. In the example, the corresponding document data is already erased and is not retained. Thus, a reduced image (past) L is generated from the preceding display image provided from the output unit 58, a state image M indicating erasion of the data is generated, the images are combined into a display image G, and the display image G is displayed on the display section 2 of the electronic paper card EP and is also stored in the image log retention unit 43.

Accordingly, for example, if shared document data associated with plural electronic paper cards was accessed using one electronic paper A and was erased, when an attempt is made to access the data using different electronic paper B, the image generated using the display image displayed on the electronic paper A is displayed on the electronic paper B, so that the user sees the electronic paper B and can understand that the document data is already erased and can also understand an outline of the already erased document data.

What is claimed is:

1. An electronic paper system that uses an electronic paper comprising a display section displaying an image in a no-power supply state, which comprises:
a retention unit that stores a display image in association with at least one of the document data and the electronic paper, the display image being generated from document data and displayed on the display section of the electronic paper; and
an output unit that outputs the display image stored in the retention unit.

2. The electronic paper system as claimed in claim 1,
wherein
the output unit outputs the display image associated with at least one of the document data to be processed and the electronic paper to be processed, and
the electronic paper system comprises:
an image generation unit that generates a new display image based on the display image outputted from the output unit; and
an image write unit that writes the new display image to the electronic paper to be processed, and that displays the new display image.

3. The electronic paper system as claimed in claim 2,
wherein
the electronic paper comprises:
a storage section that stores information of at least one of association information and identification information of the electronic paper, the association information associating the electronic paper with the document data,
the electronic paper system comprises:
a determination unit that determines the display image based on the information read from the storage section, the display image being associated with at least one of the document data to be processed and the electronic paper to be processed, and
the output unit that outputs the display image determined by the determination unit.

4. The electronic paper system as claimed in claim 2,
wherein
the retention unit stores the display image in association with the document data,
the output unit outputs the display image associated with the document data to be processed, and
the new display image is a comparison image of a reduced image generated from the document data to be processed and a reduced image of the display image.

5. The electronic paper system as claimed in claim 2,
wherein
the retention unit stores the display image in association with the document data,
the output unit outputs the display image associated with the document data to be processed, and
the new display image is an image combined an image explaining the state of the document data to be processed and a reduced image of the display image output by the output unit.

6. An electronic paper system comprising:
a document management apparatus that stores document data;
a log management apparatus; and
an information processing apparatus that generates a display image from the document data stored in the document management apparatus, the display image being displayed on electronic paper comprising a display section holding display of an image in a no-power supply state,
wherein
the log management apparatus comprises:
a retention unit that stores the display image in association with at least one of the document data and the electronic paper, and
the information processing apparatus comprises:
an output unit that acquires the display image from the retention unit, the display image being associated with at least one of the document data to be processed and the electronic paper to be processed, and that outputs the display image;
an image generation unit that generates a new display image based on the display image output by the output unit; and
an image write unit that writes the new display image to the electronic paper to be processed, and that displays the new display image.

7. An electronic paper system comprising:
a document management apparatus that stores document data; and
an information processing apparatus that generates a display image from the document data stored in the document management apparatus, the display image being displayed on electronic paper comprising a display section holding display of an image in a no-power supply state,
wherein
the document management apparatus comprises:
a retention unit that stores the display image in association with at least one of the document data and the electronic paper, and
the information processing apparatus comprises:
an output unit that acquires the display image from the retention unit, the display image being associated with at least one of the document data to be processed and the electronic paper to be processed, and that outputs the display image;
an image generation unit that generates a new display image based on the display image output by the output unit; and
an image write unit that writes the new display image to the electronic paper to be processed, and that displays the new display image.

8. An electronic paper system comprising:
a document management apparatus that stores document data; and
an information processing apparatus that generates a display image from the document data stored in the document management apparatus, the display image being displayed on electronic paper comprising a display section holding display of an image in a no-power supply state,
wherein
the log management apparatus comprises:
an retention unit that stores a display image generated from document data and displayed on the display section of the electronic paper in association with at least one of the document data and the electronic paper;
an output unit that acquires the display image from the retention unit, the display image being associated with at least one of the document data to be processed and the electronic paper to be processed, and that outputs the display image;
an image generation unit that generates a new display image based on the display image output by the output unit; and
an image write unit that writes the new display image to the electronic paper to be processed, and that displays the new display image.

9. A log management apparatus that forms a part of an electronic paper system using an electronic paper comprising a display section displaying an image in a no-power supply state, which comprises:
a retention unit that stores the display image generated from document data in association with at least one of the document data to be processed and the electronic paper to be processed so as to output the display image.

10. An information processing apparatus that forms a part of an electronic paper system using an electronic paper comprising a display section displaying an image in a no-power supply state, which comprises:
an output unit that acquires the display image associated with at least one of the document data to be processed and the electronic paper to be processed from a display image stored in electronic paper system, and that outputs the display image acquired;
an image generation unit that generates a new display image using the output display image; and
an image write unit that writes the new generated display image to the electronic paper to be processed and displaying the new display image.

11. A computer readable medium storing a program causing a computer to execute a process for storing a display image written in an electronic paper, which comprises:
storing the display image in association with at least one of the document data to be processed and the electronic paper to be processed so as to output the display image.

12. A computer readable medium storing a program causing a computer to execute a process for storing a display image written in an electronic paper, which comprises:
acquiring the display image from the display image stored, the display image being associated with at least one of document data to be processed and the electronic paper to be processed;
outputting the display image acquired;
generating a new display image based on the display image output;
writing the new display image to the electronic paper to be processed; and
displaying the new display image on the electronic paper.

13. A method of image processing, which comprises:
storing a display image generated from document data and displayed on the display section of the electronic paper in association with at least one of the document data and the electronic paper;
acquiring the display image from a retention unit, the display image being associated with at least one of the document data to be processed and the electronic paper to be processed;
displaying on electronic paper;
outputting the display image acquired;
generating a new display image based on the display image output;
writing the new display image to the electronic paper to be processed; and
displaying the display image on the electronic paper.

14. A computer data signal embodied in a carrier wave for enabling a computer to perform a process for storing a display image written in an electronic paper, which comprises:
storing a display image generated from document data and displayed on the display section of the electronic paper in association with at least one of the document data and the electronic paper;
acquiring the display image from a retention unit, the display image being associated with at least one of the document data to be processed and the electronic paper to be processed;
displaying on electronic paper;
outputting the display image acquired;
generating a new display image based on the display image output;
writing the new display image to the electronic paper to be processed; and
displaying the display image on the electronic paper.
